(19) United States
(12) Patent Application Publication
(10) Pub. No.: US 2003/0034943 A1
(43) Pub. Date: Feb. 20, 2003

(54) Liquid crystal display device

(76) Inventor: Nobuhiro Takeda, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/212,208

(22) Filed: Aug. 6, 2002

(30) Foreign Application Priority Data
Aug. 14, 2001 (JP) 2001-246050

(51) Int. Cl. G09G 3/36

(52) U.S. Cl. 345/87

(57) ABSTRACT

In a liquid crystal display device having a plurality of pixels arranged in a matrix manner and regard each group of the pixels arranged along every gate signal line as a line, the present invention provides means for accumulating both signal levels of pixel data for odd-numbered lines of the pixels and for even-numbered lines of the pixels separately every frame period, means for obtaining a subtracted value by subtracting one of the accumulated values of the signal levels from another thereof, and means for transmitting alternation signal which changes voltage polarity applied to a liquid crystal layer by modifying a phase thereof with respect to the subtracted value, so that flickers appearing on a display screen is efficiently suppressed.

### BACKGROUND OF THE INVENTION

1. Field of the Invention

The present invention relates to a liquid crystal display device, and more particularly to an active matrix liquid crystal display device.

2. Description of the Related Art

In an active matrix liquid crystal display device, on a liquid-crystal-side surface of one substrate out of a pair of substrates which are arranged to face each other in an opposed manner while sandwiching liquid crystal therebetween, gate signal lines which extend in the x direction and are arranged parallel in the y direction and drain signal lines which extend in the y direction and are arranged parallel in the x direction are formed. Regions which are surrounded by these respective gate lines and drain lines constitute pixel regions.

Each pixel region includes a switching element which is operated in response to a scanning signal from a one-side gate signal line and a pixel electrode to which a video signal is supplied from a one-side drain signal line by way of the switching element.

The pixel electrode generates an electric field between the pixel electrode and a counter electrode which is formed on a liquid-crystal-side surface of either one of the pair of substrates and the optical transmissivity of the liquid crystal is controlled in response to the electric field.

Further, one of respective gate signal lines is selected in response to a scanning signal from a vertical scanning driving circuit and a video signal is supplied to each drain signal line from a video signal driver circuit at the timing of selection of the gate signal line.

In such a constitution, there has been known a so-called dot inversion driving method in which, to prevent the deterioration of the liquid crystal caused by polarization derived from applying of a voltage having a direct current component to the liquid crystal for a long time, the polarity of voltage applied to respective liquid crystals of neighboring pixel regions is inverted (alternated) and the polarity of voltage applied to liquid crystal is inverted every frame.

Further, as a display mode of the liquid crystal display device, a dot matrix display and a character display have been known, wherein data inputted to the above-mentioned video signal driver circuit is constituted of dot-matrix data.

Still further, in a so-called transmission type liquid crystal display device which is provided with a backlight on a back surface of a liquid crystal display panel, displaying is usually performed while setting the brightness of the backlight at a fixed value.

### SUMMARY OF THE INVENTION

However, in such a liquid crystal display device which adopts the above-mentioned dot inversion driving method, there inevitably exists a display pattern which offsets the alternation of liquid crystal driving and it has been pointed out that flickers occur in such a case.

Further, it has been also pointed out that the dot-matrix data inputted to the above-mentioned video signal driver circuit increases power consumption for transferring such data.

Still further, recently, it has been pointed out that not only still images but also moving images are visualized in large quantity as display images and brightness of images is slightly reduced when the moving images are visualized and hence, the moving images cannot be clearly recognized.

The present invention has been made in view of such circumstances and it is an object of the present invention to provide a liquid crystal display device which can suppress the generation of flickers.

It is another object of the present invention to provide a liquid crystal display device which can reduce the power consumption thereof.

It is still another object of the present invention to provide a liquid crystal display device which can clearly display moving images.

To simply explain typical inventions among the inventions disclosed in the present application, they are as follows.

Structural Feature 1 according to the Present Invention

In a liquid crystal display device which has pixels arranged in a matrix manner each group by forming respective lines along gate signal lines, and comprises means for alternating polarities of voltages applied to a liquid crystal during a frame period with respect to an alternation signal, the present invention provides:

means for accumulating signal levels of pixel data for odd-numbered lines of the pixels every frame period (accumulator A);

means for accumulating signal levels of pixel data for even-numbered lines of the pixels every frame period (accumulator B);

subtracting means for obtaining a subtracted value by subtracting one of the accumulated values of the signal levels for the odd-numbered lines and the even-numbered lines from another thereof (subtractor), and

alternation signal transmitter means for transmitting another alternation signal different from (e.g. out of the phase with) the alternation signal when the subtracted value obtained by the subtracting means is not less than a reference value (e.g. selector).

In a liquid crystal display device having such a constitution, there is no possibility that the voltage applying polarity and the display data are biased and hence, the liquid crystal applying voltage is made uniform with respect to the common voltage. Accordingly, it is unnecessary to increase a current quantity of the common electrode so that the power consumption can be suppressed.

Structural Feature 2 according to the Present Invention

The structural feature 2 of the liquid crystal display device according to the present invention is defined for example by (a) means for receiving an input datum including a character display and a dot matrix data and producing the dot matrix datum from the input datum when a display enable signal is in a High-state (e.g. a logic element receiving the input data and the display enable signal); (b) means for generating a character datum from the input datum when a display enable signal is in a Low-state (e.g. a color palette converting circuit, a character-generating circuit, or a character-address generating circuit, and a logic element disposed prior thereto); and (c) means for outputting a display data by synthesizing the character datum with the dot matrix datum (e.g. an image synthesizing circuit), each provided for the liquid crystal display device.

In the liquid crystal display device having such a constitution, when the character display is performed along with the dot matrix display, input data for the character display is fetched as the character data and is synthesized with the dot-matrix data. Due to such a constitution, the power consumption necessary for data transfer can be reduced.

Structural Feature 3 according to the Present Invention

In a liquid crystal display device having a liquid crystal display panel to which a display datum is inputted and a backlight arranged at a back surface of the liquid crystal display panel, the present invention provides:

a first means for identifying gray scales in respective pixel datum included in the display datum (e.g. a gray scale decoder);

a second means for detecting each existence of predetermined gray scale levels in the gray scales identified by the first means (e.g. gray scale resistors provided for every predetermined gray scale level);

a third means for totaling up a number of the gray scale levels detected by the second means (e.g. an adder);

a fourth means for outputting an control signal to the backlight lying one of a plurality of brightness control ranges of the backlight with respect to the number of the gray scale levels totaled up by the third means wherein the fourth means divides a brightness range of the backlight to be regulated thereby into the plurality of brightness control ranges (e.g. a resistor).

In the liquid crystal display device having such a constitution, moving images displayed on the liquid crystal display panel are displayed with brightness which is greater than brightness which is obtained when still images are displayed.

Due to such a constitution, the motion of the moving images can be clearly displayed. On the other hand, it is also confirmed that when the display images are still images, the still images can be clearly displayed even when the brightness is not so large.

Further, the distinction between the moving images and the still images is detected and the optimum brightness display is performed in response to the result of detection and hence, it is possible to obtain an advantageous effect that the power consumption can be reduced.

### BRIEF DESCRIPTION OF THE DRAWINGS

FIG. 1 is a circuit diagram of an essential part showing one embodiment of a liquid crystal display device according to the present invention;

FIG. 2 is an equivalent circuit diagram showing one embodiment of a liquid crystal display panel of the liquid crystal display device according to the present invention;

FIG. 3 is a circuit diagram showing a circuit of the liquid crystal display panel and a periphery thereof of the liquid crystal display device according to the present invention;

FIG. 4 is a circuit diagram showing one embodiment of a driving voltage generator circuit of the liquid crystal display device according to the present invention;

FIG. 5 is an explanatory view showing an advantageous effect obtained by the provision of the circuit shown in FIG. 1 of the liquid crystal display device according to the present invention;

FIG. 6 is an explanatory view showing drawbacks of a conventional liquid crystal display device and corresponds to FIG. 5;

FIG. 7 is a circuit diagram of an essential part showing another embodiment of the liquid crystal display device according to the present invention; and

FIG. 8 is a circuit diagram of an essential part showing another embodiment of the liquid crystal display device according to the present invention.

### DETAILED DESCRIPTION

Preferred embodiments of a liquid crystal display device according to the present invention are explained hereinafter in conjunction with drawings.

### Embodiment 1

<<Circuit Diagram of Liquid Crystal Display Panel PNL>>

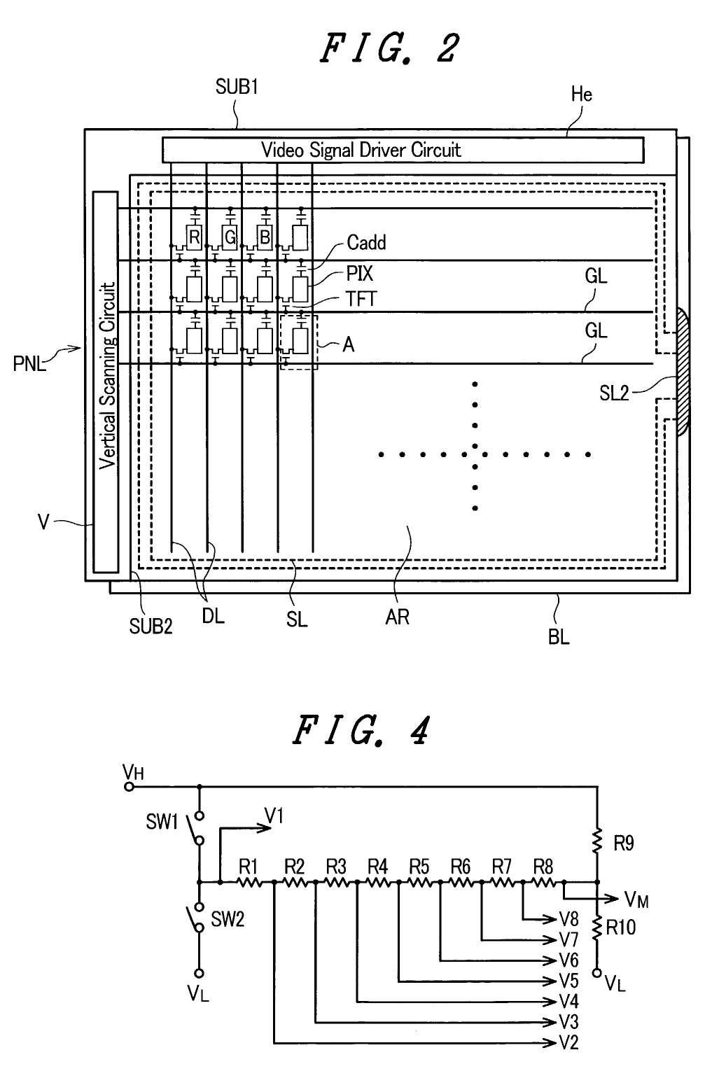

FIG. 2 is a view showing a circuit of a liquid crystal display panel PNL. Although the drawing shows the circuit diagram, it is depicted corresponding to an actual geometric arrangement.

First of all, there is provided a transparent substrate SUB1. On a surface (surface which faces a transparent substrate SUB2 which will be explained later in an opposed manner), gate signal lines GL which extend in the x direction and are arranged in parallel in the y direction and drain signal lines DL which extend in the y direction and are arranged in parallel in the x direction are formed.

Regions surrounded by the gate signal lines GL and the drain signal lines DL constitute pixel regions (pixels) and these respective pixels constitute a liquid crystal display portion AR in the inside of regions which are arranged in a matrix array.

On each pixel region, a switching element (thin film transistor) TFT which is operated in response to a scanning signal from a one-side gate signal line GL and a pixel electrode PIX to which a video signal from a one-side drain signal line DL is supplied through the switching element TFT are formed.

The pixel electrode PIX generates an electric field between the pixel electrode PIX and a counter electrode CT (not shown in the drawing) which is provided either one of respective transparent substrates and the optical transmissivity of the liquid crystal is arranged to be controlled by the electric field.

Each gate signal line GL has one end side thereof connected to a vertical scanning driving circuit V and the scanning signal is supplied to each gate signal line GL from the vertical scanning driving circuit V.

Further, each drain signal line DL has one end side thereof connected to a video signal driver circuit He and a video signal is supplied to each drain signal line DL from the video signal driver circuit He.

Here, respective drain signal lines DL are constituted of signal lines which sequentially repeat color display of R, G, B from a left end side thereof, for example. Accordingly, three pixels which are arranged close to each other and in charge of respective gate signal lines GL constitute one pixel in color display.

The above-mentioned transparent substrate SUB1 is arranged to face other transparent substrate SUB2 by way of liquid crystal and a sealing material SL which surrounds the above-mentioned liquid crystal display portion AR to seal the liquid crystal is used for fixing the above-mentioned transparent substrates SUB1, SUB2.

Further, the liquid crystal display panel PNL having such a constitution is of a so-called transmission type and a backlight BL is arranged on a back surface of the panel PNL.

<<Circuit of Liquid Crystal Display Panel PNL and Periphery Thereof>>

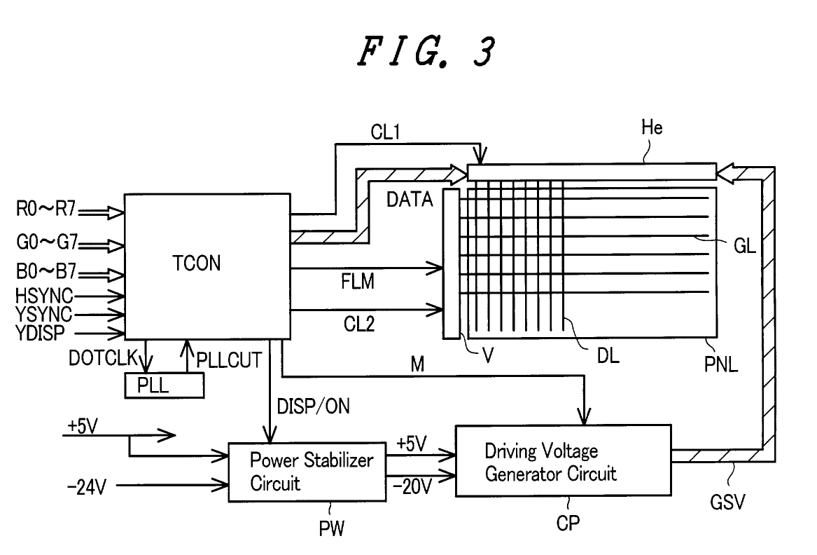

FIG. 3 is a view showing a circuit of the above-mentioned liquid crystal display panel PNL and a periphery thereof.

For the sake of brevity, a case in which the liquid crystal display device is served for color display of 256 colors, for example, is shown in FIG. 3.

First of all, an interface part which corresponds to a microcomputer system or the like is constituted of a timing converter TCON.

To an input terminal of this timing converter TCON, color data R₀-R₇, G₀-G₇, B₀-B₇ which correspond to inputs of R, G, B of a standard color CRT (cathode ray tube), a horizontal synchronizing signal HSYNC, a vertical synchronizing signal VSYNC, a display timing signal YDISP and the like are inputted.

Further, signals which are obtained by converting respective data from the above-mentioned input terminal and drive the liquid crystal display panel PNL are outputted from an output terminal of the timing converter TCON.

A phase locked loop circuit PLL is connected to the timing converter TCON and a 1 dot clock pulse DOTCLK is inputted to the timing converter TCON by this phase locked loop circuit PLL.

The vertical scanning driving circuit V which is mounted on the liquid crystal display panel PNL is constituted of a dynamic-type shift resister and a driver, for example, wherein a frame signal (FLM signal) and a pulse CL2 which corresponds to scanning timing are inputted to the vertical scanning driving circuit V from the output terminal of the above-mentioned timing converter TCON.

Due to such a constitution, the scanning signal is sequentially outputted to respective gate signal lines GL which are respectively connected to an output terminal of the vertical scanning driving circuit V.

Further, to the video signal driver circuit He mounted on the liquid crystal display panel PNL, a clock pulse CL1 which is outputted from the output terminal of the timing converter TCON and data DATA of several bit unit which is transmitted in serial through a signal bus are inputted.

The clock pulse CL1 is served for latching the above-mentioned data DATA at the video signal driver circuit He for one line transferred in the serial order.

That is, the clock pulse CL1 is generated when the transfer of data for one line is completed. The transferred data is held and a driving voltage for one line is formed based on the data, and is written in parallel in the pixel for one line corresponding to the gate signal line GL selected by the above-mentioned vertical scanning driving circuit V.

In this case, along with the above-mentioned writing into the pixel, the serial fetching of data corresponding to a next line is performed in response to the above-mentioned clock pulse CL1.

On the other hand, there is provided a power stabilizer circuit PW and the circuit PW generates stabilized voltages such as +5V and −20V which are necessary as driving voltages upon receiving two voltages such as +5V and −24V, for example.

The power stabilizer circuit PW is effectively operated upon receiving a display control signal DISP/ON from the above-mentioned timing converter TCON.

Further, the stabilized voltages from the power stabilizer circuit PW are supplied to a driving voltage generator circuit CP and the driving voltage generator circuit CP generates respective driving voltages GSV allocated to respective gray scales and respective driving voltages are supplied to the video signal driver circuit He.

<<Driving Voltage Generator Circuit>>

FIG. 4 shows one example of the above-mentioned driving voltage generator circuit CP, wherein the driving voltages (also called “Gray Scale Voltage”, GSV in FIG. 3) which are outputted in response to gray scales are configured to invert polarities thereof to positive/negative polarity in every gate signal line GL and every frame.

Due to such a constitution, the liquid crystal is subjected to a so-called alternation driving (counter electrode being fixed in this case) and hence, there is no possibility that a direct current component is applied to the liquid crystal whereby it is possible to obtain an advantageous effect that the lifetime of the liquid crystal is prolonged.

In the drawing, a series circuit including a switch SW1 and a switch SW2 is connected between a high-level side voltage V_{H} (+5V for an example of FIG. 3) and a low-level side voltage V_{L} (−20V for the example of FIG. 3) and a driving voltage V₁ is outputted from a connection point of respective switches SW1 and SW2.

Further, a series circuit including a register R₉ and a register R₁₀ is connected between the high-level side voltage V_{H} and the low-level side voltage V_{L}, and an intermediate voltage V_{M} is generated at a connection point of respective registers R₉ and R₁₀.

With respect to the switches SW1 and SW2, when one of them assumes the ON state, the other assumes the OFF state. This changeover is performed in response to the changeover of the gate signal lines GL, for example.

A series circuit consisting of registers R₁ to R₈ is connected between a connection point of respective registers R₉ and R₁₀ and a connection point of the switches SW1 and SW2, wherein respective driving voltages V₂ to V₈ are outputted from lines between each of respective registers R₁ to R₈.

Respective driving voltages GSV outputted from the driving voltage generator circuit CP include voltages of 8 stages and adopt the descending order of driving voltages V₁ to V₈.

Due to such a constitution, when the odd-numbered gate signal lines GL are selected, the switch SW1 becomes the ON state in response to the signal M from the above-mentioned timing converter TCON and the driving voltage of positive polarity +V₁ to +V₈ are formed in response to the high-level side voltage V_{H} and the intermediate voltage V_{M}. Then, when the even-numbered gate signal lines GL are selected, the switch SW2 becomes the ON state in response to the signal M from the above-mentioned timing converter TCON and the driving voltage of negative polarity −V₁ to −V₈ are formed in response to the low-level side voltage V_{H} and the intermediate voltage V_{M}.

Such changeover of the switches SW1 and SW2 is performed every changeover of frame.

Here, in this embodiment, with respect to a pixel group driven by respective gate signal lines GL, the polarities of voltages applied to respective liquid crystals of the pixels which are arranged to close each other are also inverted. This inversion is performed in the inside of the above-mentioned video signal driver circuit He, for example.

<<Voltage Polarity Inversion Adjusting Circuit>>

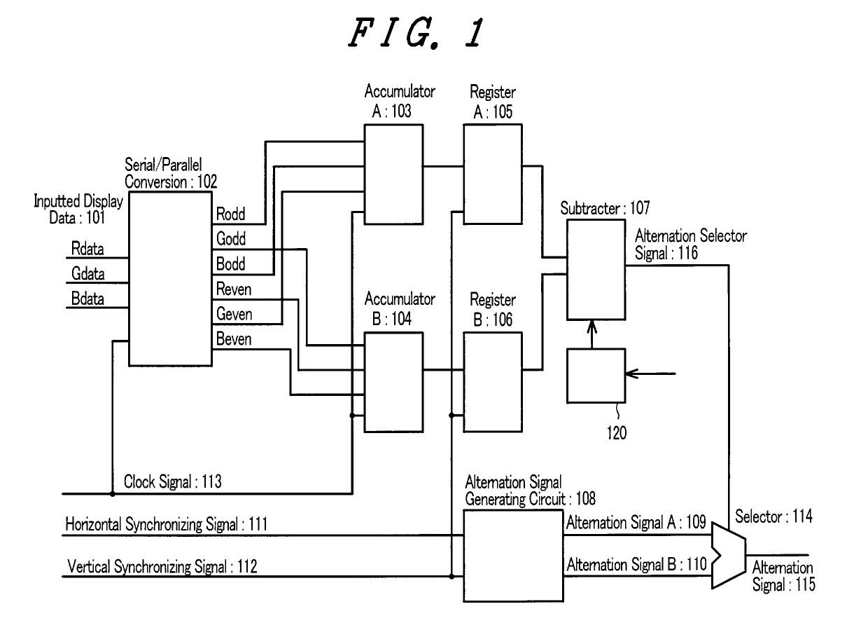

FIG. 1 shows a circuit for adjusting the above-mentioned inversion of polarity of voltage applied to the liquid crystal in response to input data inputted to the timing controller TCON (hereinafter referred to as inputted display data) and this circuit is incorporated into the above-mentioned timing controller TCON, for example.

In the drawing, first of all, there is provided a serial/parallel converter 102. Inputted display data 101 is configured to be inputted into this serial/parallel converter 102.

The inputted display data 101 includes a large number of pixel data and these pixel data are outputted from the serial/parallel converter 102 after being classified into pixel data of odd-numbered lines and the pixel data of even-numbered lines in vertical scanning of the liquid crystal display part.

Further, respective pixel data of the inputted display data 101 respectively include respective information on red (R), green (G), blue (B) of color display and inputting of the inputted display data 101 to the serial/parallel converter 102 is performed through different input terminals Rdata, Gdata, Bdata which correspond to respective information of red (R), green (G), blue (B) for every pixel data. The outputting of the inputted display data 101 from the serial/parallel converter 102 is performed through different output terminals Rodd, Godd, Bodd which correspond to respective information of red (R), green (G), blue (B) of respective pixel data of the odd-numbered lines and is performed through different output terminals Reven, Geven, Beven which correspond to respective information of red (R), green (G), blue (B) of respective pixel data of the even-numbered lines.

Such operations are performed with respect to respective pixels which differ in color information upon inputting of a clock signal 113 to the serial/parallel converter 102.

Then, outputs from the output terminals Rodd, Bood, Geven of the serial/parallel converter 102 are inputted to an accumulator A103, while outputs from the output terminals Godd, Reven, Beven of the serial/parallel converter 102 are inputted to an accumulator B104.

In the accumulator A103, the signal levels (corresponding to brightness) of respective pixel data which are inputted to the accumulator A103 are sequentially accumulated and an accumulated value is designed to be temporarily stored in a register A105.

Further, simultaneously, in the accumulator B104, the signal levels of respective pixel data which are inputted to the accumulator B104 are sequentially accumulated and an accumulated value is designed to be temporarily stored in a register B106.

Clock signals 113 are respectively inputted to the accumulators A103, B104 and the accumulations in the accumulators A103, B104 are performed for respective pixels which differ in color information. On the other hand, vertical synchronizing signals 112 are inputted to the registers A105, B106 respectively and the accumulations in the registers A105, B106 are performed every frame of the liquid crystal display.

That is, due to such a constitution, it is possible to obtain the accumulated value of signal levels of pixel data (R, G, B) of respective odd-numbered lines and the accumulated value of signal levels of pixel data (R, G, B) of respective even-numbered lines every one frame.

Then, signals which correspond to respective accumulated values are inputted to a subtracter 107. The subtraction between the accumulated value stored in the register A105 and the accumulated value stored in the register B106 is performed by the subtracter 107.

The substractor 107 outputs an alternation selector signal 116 when a subtracted value calculated by the substractor 107 becomes equal to or more than a reference value.

Here, the above-mentioned substractor 107 allows inputting of a signal from a reference value changing means 120 which changes the reference value so that the reference value can be arbitrarily set.

Here, an operator can operate the reference value changing means 120 so as to change the reference value to a given value based on the observation of a display surface of liquid crystal, for example.

On the other hand, there is provided an alternation signal generating circuit 108. The alternation signal generating circuit 108 generates an alternation signal A109 and an alternation signal B110 whose phases are shifted by 180° in response to inputting of a horizontal synchronizing signal 111 and a vertical synchronizing signal 112.

These alternation signals A109, B110 are inputted to a selector 114 and the selector 114 changes over either one of alternation signals A109, B110 based on the selection of the alternation selector signal 116 and outputs an alternation signal 115.

The alternation signal 115 is used as a signal for changing over switches SW1, SW2 of the driving voltage generator circuit CP and is used for the inversion of polarities of the neighboring pixels in the pixel group in each line in the video signal driver circuit He.

The liquid crystal display device having such a constitution detects a case in which there exists a bias with respect to display data quantities of positive polarity and negative polarity in one frame and changes the alternation period of the liquid crystal thus suppressing the generation of flickers and the increase of the power consumption.

With respect to the generation of the alternation period of the liquid crystal of the conventional liquid crystal display device which is not constituted in such a manner, a display pattern which offsets the alternation exists and hence, flickers are generated. Further, there has been a drawback that due to the bias of the display data at the positive polarity and the negative polarity with respect to the polarity of voltage applied to the liquid crystal, the current to the common electrode is increased whereby the power consumption is increased.

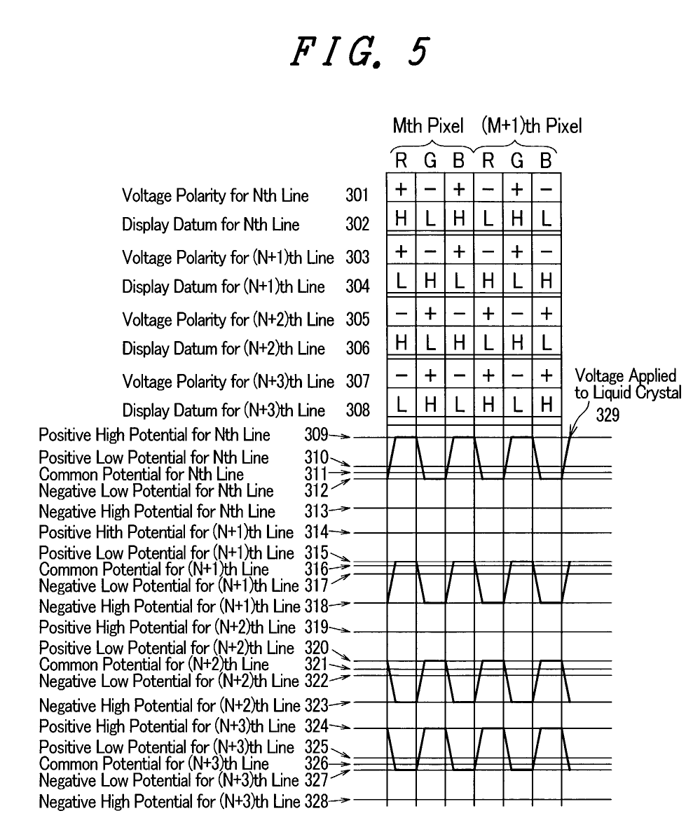

FIG. 5 is a view showing one embodiment of the relationship between the liquid crystal applying voltage and the alternation signal established by the above-mentioned constitution.

As can be understood from FIG. 5, while the white and black inversion pattern is inputted every dot and every line, the alternation signal is changed every dot and every two lines. Accordingly, there is no possibility that the polarity of applied voltage 301, 303, 305, 307 and the display data 302, 304, 306, 308 are biased, and the liquid crystal applying voltage 329 is made uniform with respect to common voltages 311, 316, 321, 326. Accordingly, a current quantity of the common electrodes is not increased and hence, the power consumption can be suppressed.

Further, due to similar reasons, it is possible to suppress the generation of flickers derived from the non-uniformity of common electrodes on the display screen of the liquid crystal display panel.

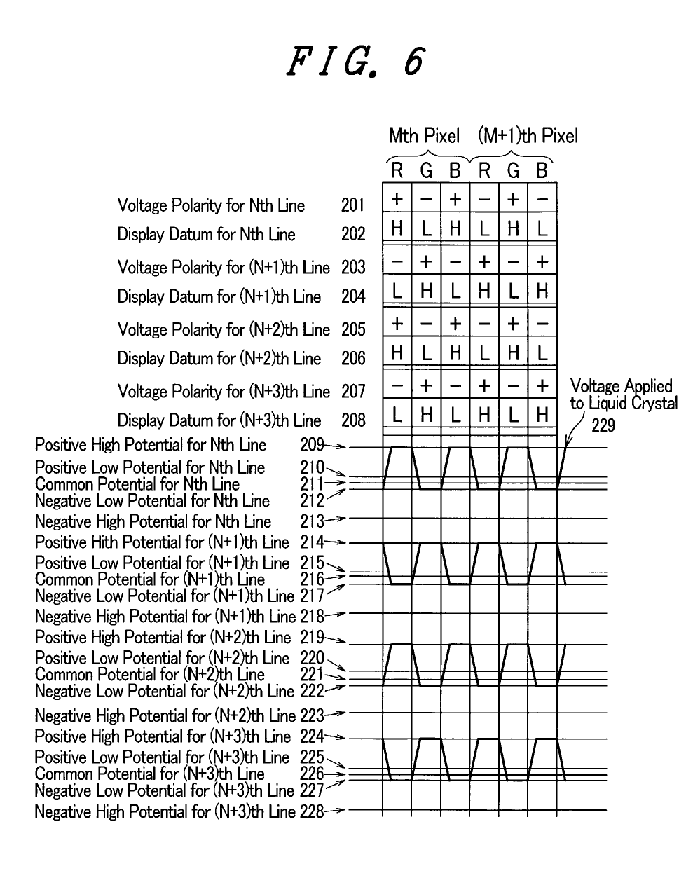

FIG. 6 is a view showing one example of the relationship between the liquid crystal applying voltage and the alternation signal in the conventional liquid crystal display device and corresponds to FIG. 5. As can be understood from FIG. 6, the alternation signal is fixed and hence, when the display data is formed of the white and black inversion pattern of every dot and every line, the polarity of applying voltage 201, 203, 205, 207 and the display data 201, 204, 206, 208 are biased whereby the liquid crystal applying voltage 229 is biased with respect to the common electrodes.

### Embodiment 2

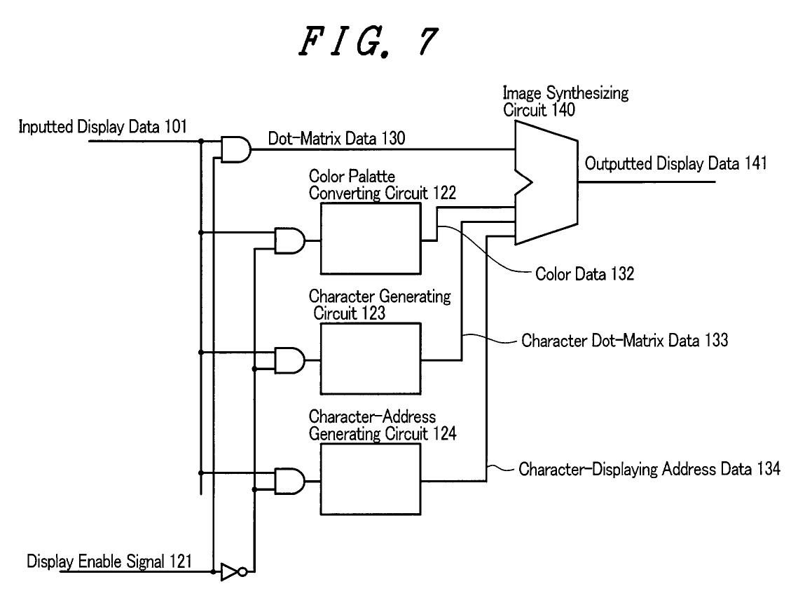

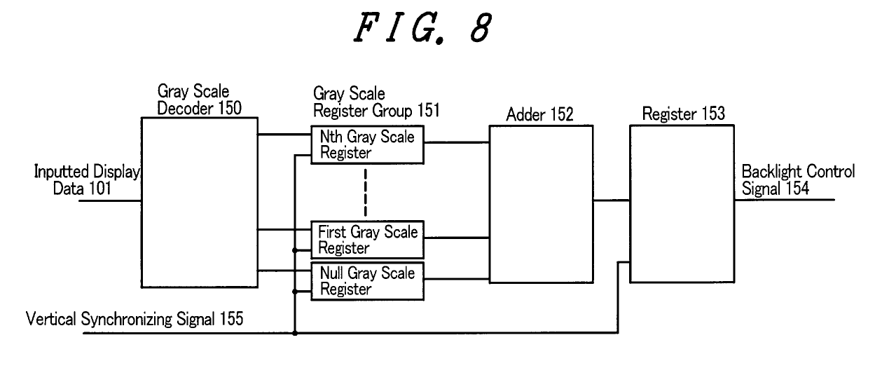

FIG. 7 is a circuit diagram showing another embodiment of the liquid crystal display device according to the present invention and shows a circuit incorporated in the inside of the above-mentioned timing converter TCON, for example.

In the drawing, inputted display data 101 are acquired as dot-matrix data 130 during periods in which a display enable signal 121 assumes the HIGH period. Meanwhile, the inputted display data 101 are acquired as a color code, a character code and a character-address code and inputted into a color palette converting circuit 122, a character generating circuit 123 and a character-address generating circuit 124, respectively during periods in which the display enable signal 121 assumes the LOW period (fly-back period).

The data acquired as the dot-matrix data 130 are inputted to an image synthesizing circuit 140 and is synthesized with respective data which will be explained later by the image synthesizing circuit 140.

The data acquired as the color codes are inputted to the color palette converting circuit 122, and the color palette converting circuit 122 generates color data 132 and outputs the color data 132 therefrom.

The data acquired as the character code are inputted to the character generating circuit 123, and the character generating circuit 123 generates character dot-matrix data 133 and outputs the character dot-matrix data 133 therefrom.

The data acquired as the character-address code are inputted into the character-address generating circuit 124, and the character-address generating circuit 124 generates character-displaying address data 134 and outputs the character-displaying address data 134 therefrom.

The color data 132, the character dot-matrix data 133 and the character-displaying address data 134 are respectively inputted to the image synthesizing circuit 140 and these respective data are synthesized with each other along with the above-mentioned dot-matrix data 130.

The synthesized data are outputted as output display data 141 from the image synthesizing circuit 140 and is inputted to the video driving circuit He shown in FIG. 3.

In the liquid crystal display device having such a constitution, when the character display is performed along with the dot matrix display, the input data for character display are acquired as the character data 133 and are synthesized with the dot-matrix data 130. Accordingly, the power consumption for data transfer can be reduced.

When the frequency of the character display in the pixel display is increased, the power consumption reduction effect becomes apparent and hence, the liquid crystal display device is also applicable to the liquid crystal display for a portable telephone, for example, in which the drastic reduction of power consumption is demanded.

### Embodiment 3

FIG. 8 is a circuit diagram showing another embodiment of the liquid crystal display device according to the present invention and shows a circuit which is incorporated into the inside of the above-mentioned timing converter TCON.

In FIG. 8, first of all, there is provided a gray scale decoder 150 and inputted display data 101 is inputted into the gray scale decoder 150.

The inputted display data 101 is constituted of a large number of pixel data which have respective gray scales ranging from 0 to N. The gray scale decoder 150 classifies respective pixel data in accordance with respective gray scales. When there exists the pixel data which corresponds to the gray scale in accordance with respective gray scales, a signal of “1”, for example, is outputted and when there exists no pixel data which corresponds to the gray scale in accordance with respective gray scales, a signal of “0”, for example, is outputted.

That is, the gray scale decoder 150 includes (N+1) pieces of output terminals, wherein the gray scale decoder 150 outputs a signal indicative of presence/absence of pixel data of null gray scale, a signal indicative of presence/absence of pixel data of first gray scale, a signal indicative of presence/absence of pixel data of second gray scale, . . . , or a signal indicative of presence/absence of pixel data of Nth gray scale in the inputted display data 101 from the corresponding output terminal.

Here, even when the inputted display data 101 includes a plurality of pixel data of Nth gray scale, for example, the gray scale decoder 150 outputs a signal of “1” from the corresponding output terminal irrespective of the number of the pixel data.

Further, respective outputs from the gray scale decoder 150 are inputted to a gray scale register group 151 consisting of a null gray scale register, a first gray scale register, . . . , and an Nth gray scale register respectively.

That is, the signal indicative of presence/absence of the null gray scale pixel data outputted from the gray scale decoder 150 is inputted to the null gray scale register, the signal indicative of presence/absence of the first gray scale pixel data outputted from the gray scale decoder 150 is inputted to the first gray scale register, . . . , and the signal indicative of presence/absence of the Nth gray scale pixel data outputted from the gray scale decoder 150 is inputted to the Nth gray scale register.

Accordingly, either one of the signal of “1” and the signal “0” is stored in respective gray scale registers which constitute the gray scale resister group 151.

Further, respective outputs of the respective gray scale registers are inputted to an adder 152.

The adder 152 adds respective outputs from the respective gray scale registers and outputs a signal corresponding to the added value.

For example, when all “1” signals are inputted to the adder 152 from the null gray scale register, the first gray scale register, . . . , and the Nth gray scale register respectively, a signal which corresponds to the added value (N+1) of respective signals is outputted. Further, when the signal of “1” is inputted to the adder 152 from the fourth gray scale register and the sixth gray scale register and the signal of “0” is inputted to the adder 152 from other respective remaining gray scale registers, a signal which corresponds to the added value (2) of respective signals is inputted to the adder 152.

As can be understood from the above, the adder 152 detects the degree of change of the gray scales in the inputted display data 101.

That is, the adder 152 detects the degree of change of gray scales in the inputted display data 101 and determines whether the inputted display data 101 is data of moving images or not based on the magnitude of the degree of change of the gray scales, that is, based on the output of the adder 152.

When the degree of change of gray scales is large, the image is regarded as an image which includes motion and accordingly is determined as a moving image, while when the degree of change of gray scales is small, the image is regarded as an image which does not include motion and accordingly is determined as a still image which is used in word processing, table calculation, mail or the like.

Then, an output from the adder 152 is inputted to and held by a register 153 and, thereafter, is outputted as a backlight control signal 154. The backlight control signal 154 is inputted to a backlight BL arranged on a back surface of the above-mentioned liquid crystal display panel PNL and changes the brightness of the backlight BL.

A vertical synchronizing signal 155 is inputted to the respective gray scale registers of the above-mentioned gray scale register group 151 and the register 153 and the respective gray scale registers of the above-mentioned gray scale register group 151 and the register 153 are reset by this vertical synchronizing signals 155.

Accordingly, the control signals from the register 153 to the backlight BL are generated every inputted display data which corresponds to one screen.

In the liquid crystal display device having such a constitution, the moving image displayed on the liquid crystal display panel PNL is displayed with brightness greater than brightness obtained in the display of still images.

Accordingly, it is possible to clearly display the motion of the moving image. On the other hand, it is confirmed that it is possible to clearly display the still image even when the brightness is not so large.

Further, by detecting the distinction between the moving image and the still image and by performing the display with optimum brightness corresponding to the detection, it is possible to obtain an advantageous effect that the power consumption can be reduced.

Although the above-mentioned respective embodiments describe different constitutions, it is needless to say that two or all of these circuits described in the embodiments can be combined.

Further, it is needless to say that by providing the changeover means to conventional constitution such that the respective circuits can be operated by way of these changeover means.

As can be clearly understood from the foregoing explanation, according to the liquid crystal display device of the present invention, it is possible to suppress the generation of flickers. It is also possible to reduce the power consumption. It is further possible to clearly display the moving images.

What is claimed is:

1. A liquid crystal display device which has pixels arranged in a matrix manner each group by forming respective lines along gate signal lines, and comprises means for alternating polarities of voltages applied to a liquid crystal during a frame period with respect to an alternation signal, comprising:
means for accumulating signal levels of pixel data for odd-numbered lines of the pixels every frame period,
means for accumulating signal levels of pixel data for even-numbered lines of the pixels every frame period,
subtracting means for obtaining a subtracted value by subtracting one of the accumulated values of the signal levels for the odd-numbered lines and the even-numbered lines from another thereof, and
alternation signal transmitter means for transmitting alternation signal different from the alternation signal when the subtracted value obtained by the subtracting means is not less than a reference value.

2. A liquid crystal display device according to claim 1, further comprising means for altering the reference value.

3. A liquid crystal display device comprising:
means for receiving an input datum including a character display and a dot matrix data and producing the dot matrix datum from the input datum when a display enable signal is in a High-state;
means for generating a character datum from the input datum when a display enable signal is in a Low-state; and
means for outputting a display data by synthesizing the character datum with the dot matrix datum.

4. A liquid crystal display device according to claim 3, wherein the means for generating the character datum comprises at least a color palette conversion circuit, a character generating circuit, and a character address generating circuit.

5. A liquid crystal display device having a liquid crystal display panel to which a display datum is inputted and a backlight arranged at a back surface of the liquid crystal display panel, comprising:
a first means for identifying gray scales in respective pixel datum included in the display datum;
a second means for detecting each existence of predetermined gray scale levels in the gray scales identified by the first means;
a third means for totaling up a number of the gray scale levels detected by the second means;
a fourth means for outputting an control signal to the backlight lying one of a plurality of brightness control ranges of the backlight with respect to the number of the gray scale levels totaled up by the third means wherein the fourth means divides a brightness range of the backlight to be regulated thereby into the plurality of brightness control ranges.

6. A liquid crystal display device according to claim 5, wherein the control signal for the backlight is generated for every display datum inputted into the liquid crystal display panel with respect to one image displayed thereby.
